(19) United States
(12) Patent Application Publication
(10) Pub. No.: US 2002/0099962 A1
(43) Pub. Date: Jul. 25, 2002

(54) Information processing apparatus suitably controlling activation and stoppage of power consumption reducing function and power consumption controlling method of the apparatus

(75) Inventor: Koji Nakamura, Akiruno-shi (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/011,699

(22) Filed: Nov. 13, 2001

(30) Foreign Application Priority Data
Jan. 25, 2001 (JP) 2001-017073

(51) Int. Cl. G06F 1/26; G06F 1/28; G06F 1/30

(52) U.S. Cl. 713/300

(57) ABSTRACT

A microcomputer has a power consumption reducing function which may be activated and de-activated with a time delay provided by a hysteresis current. The microcomputer communicates with a memory incorporated in a battery pack. It reads from the memory the rated discharge current data specific to the battery pack, and stores it as a first predetermined value which corresponds to a current value at which the power consumption reducing function is activated. The power microcomputer subtracts the hysteresis current (defined as the maximum value of the reduced discharge current of the battery pack while the power consumption reducing function is active) from the first predetermined value, and stores the calculated value as a second predetermined value which corresponds to a current value at which the power consumption reducing function is de-activated. The hysteresis current prevents rapid cycling through activation and de-activation of the power consumption reducing function.

### CROSS-REFERENCE TO RELATED APPLICATIONS

This application is based upon and claims the benefit of priority from the prior Japanese Patent Application No. 2001-017073, filed Jan. 25, 2001, the entire contents of which are incorporated herein by reference.

### BACKGROUND OF THE INVENTION

1. Field of the Invention

The present invention relates to an information processing apparatus with a power consumption reducing function to temporarily reduce the power consumption, and to a power consumption controlling method of the apparatus. Particularly, the present invention relates to an information processing apparatus that allows suitable control of activation and stoppage of a power consumption reducing function, and to a power consumption controlling method of the apparatus.

2. Description of the Related Art

In recent years, various portable and battery-driven information processing apparatuses have been developed. For example, a PDA (Personal Digital Assistant) terminal is one of such apparatuses. The information processing apparatuses of this type have become more advanced in function and smaller in size day by day. Accordingly, the power source of such an apparatus also becomes increasingly compact.

To reduce the size of a power source, it is inevitably necessary to reduce power consumption at the time of maximum power consumption. For this purpose, information equipment disclosed in, for example, Jpn. Pat. Appln. KOKAI Publication No. 10-268986, has a power consumption reducing function to temporarily reduce the power consumption by (1) reducing the CPU clock rate, (2) reducing the backlight brightness, and (3) causing “CPU interruption” to make the CPU idle. The power consumption reducing function is activated, when the power consumption inside the equipment exceeds a predetermined value.

The information equipment disclosed in Jpn. Pat. Appln. KOKAI Publication No. 10-268986 includes a resistor connected in series to a power supply line and a power measuring circuit in order to monitor the amount of power consumed inside the equipment. The power measuring circuit compares an analog voltage representing power consumption caused by voltage drop at both ends of the resistor with an analog voltage representing a predetermined value.

With this structure, even if the information equipment includes a device that consumes a large amount of power during operation, such as a hard disk device, the power consumption can be suppressed within a predetermined range by, for example, temporarily reducing the CPU clock rate.

The performance of the CPU mounted in this type of information processing apparatus has been dramatically increasing. Accordingly, the power consumed by the CPU has considerably increased. Recently, the ratio of the power consumption of the CPU to that of the other devices in the apparatus is predominantly large. Thus, to reduce the power requirements of the entire apparatus, it is most effective to reduce the power consumption of the CPU.

However, the power consumption of the CPU greatly varies over a wide range in a short period of time, depending on the load conditions. Therefore, in this state, if the activation and stoppage of the power consumption reducing function is controlled only based on a single predetermined value as in the information equipment disclosed in Jpn. Pat. Appln. KOKAI Publication No. 10-268986, the following problem may arise.

When the power consumption inside the equipment exceeds a predetermined value, if the power consumption reducing function is activated, thereby, for example, reducing the CPU clock rate, the power consumption inside the equipment is reduced below the predetermined value immediately after the activation. This time, the equipment is controlled to stop the power consumption reducing function. Thus, there is a problem that the activation and stoppage of the function is periodically repeated.

An AC adapter and a battery pack generally included in this type of information processing apparatus as power sources will now be considered.

In general, the AC adapter has a protection function to immediately shut off a power supplied to the equipment, when the output current exceeds a predetermined value, i.e., a rated current, even momentarily. Therefore, when the output current exceeds the predetermined value, if the battery back is empty, the power source of the system is entirely shut off. Even if the predetermined value is sufficiently low relative to the rated current of the AC adapter, the load on the power supply line will considerably vary in a short period of time due to the variance of the load on the CPU. Therefore, if the detecting circuit informs the power consumption control section that the output current exceeds the predetermined value, it is impossible to stop the protecting function of the AC adapter in time; that is, the power supply is shut off. To prevent this, the rated current of the AC adapter must be set such that the information processing apparatus can continuously operate even if the load on the CPU or the other devices is varied from the minimum to the maximum. Therefore, when the AC adapter is used as a power source, it is difficult to achieve the purpose of reducing the size of the power source. According to the conventional system, this purpose of downsizing is abandoned. In addition, the conventional system still suffers from the aforementioned problem that the activation and stoppage of the power reducing function is periodically repeated.

As regards the battery pack, it is necessary to measure not the power consumption of the equipment but the discharge current of the battery pack for the following reason. Since the voltage of the battery pack is reduced while the battery is discharged from the fully charged state to a low battery state, even if the power consumption of the equipment is constant, the discharge current of the battery pack is increased. Moreover, if the discharge current of the battery pack continuously exceeds the rated discharge current, a protecting member inside the battery pack may operate to shut off power supply to the equipment.

Therefore, to realize a battery-operation of information equipment which consumes a great amount of power at the maximum load, without lowering the performance of the equipment so far as possible, the following must be considered. When the discharge current of the battery pack is measured, if it exceeds the rated current, the power consumption reducing function is activated. Thereafter, when the function is to be stopped, it is necessary to devise means to prevent the repeated activation and stoppage of the power reducing function as described above, in consideration of the reduction of the discharge current due to control of power consumption.

### BRIEF SUMMARY OF THE INVENTION

Embodiments of the present invention provide an information processing apparatus which allows suitable control of the activation and stoppage of a power consumption reducing function, and a power consumption controlling method of the apparatus.

According to an embodiment of the invention, there is provided an information processing apparatus with a power consumption reducing function to temporarily reduce power consumption. The information processing apparatus is adapted to be driven by a battery and has a measuring device for measuring a discharge current value of the battery; a first determining device for determining whether the discharge current value measured by the measuring device exceeds a first predetermined value; a second determining device for determining whether the discharge current value measured by the measuring device is less than a second predetermined value, which is smaller than the first predetermined value; and a control device for activating the power consumption reducing function if the first determining device determines that the discharge current measured by the measuring device exceeds the first predetermined value, and after the power consumption reducing function is activated, stopping the power consumption reducing function if the second determining device determines that the discharge current value measured by the measuring device is less than the second predetermined value.

According to another embodiment of the invention, the microprocessor of the information processing apparatus retrieves battery data from the battery and calculates the plurality of first and second predetermined values based, at least in part, on the battery data. The information processing apparatus may further include a storing device for storing the first and second predetermined values.

According to yet another embodiment of the invention, there is provided an information processing apparatus with a power consumption reducing function to temporarily reduce power consumption. The apparatus comprises a measuring device for measuring a discharge current value of a power source which supplies power to operate the information processing apparatus; a first determining device for determining whether the discharge current value measured by the measuring device exceeds a first predetermined value; a second determining device for determining whether the discharge current value measured by the measuring device is less than a second predetermined value, which is smaller than the first predetermined value; and a control device for activating the power consumption reducing function if the first determining device determines that the discharge current measured by the measuring device exceeds the first predetermined value, and after the power consumption reducing function is activated, stopping the power consumption reducing function if the second determining device determines that the discharge current value measured by the measuring device is less than the second predetermined value.

According to yet other embodiments of the invention there is provided a power consumption control method of an information processing apparatus with a power consumption reducing function to temporarily reduce power consumption. The information processing apparatus is capable of driven by a battery. The method comprises measuring a discharge current value of the battery; determining whether the measured discharge current value exceeds a first predetermined value; activating the power consumption reducing function if it is determined that the measured discharge current value exceeds the first predetermined value; determining whether the measured discharge current value is less than a second predetermined value, which is smaller than the first predetermined value; and after the power consumption reducing function is activated, stopping the power consumption reducing function if it is determined that the measured discharge current value is less than the second predetermined value.

Another embodiment of the invention is directed toward a power consumption control method of an information processing apparatus which has a power consumption reducing function to temporarily reduce power consumption. The method comprises measuring a discharge current value of the battery; determining whether the measured discharge current exceeds a first predetermined value; activating the power consumption reducing function if it is determined that the measured discharge current value exceeds the first predetermined value; determining whether the measured discharge current value is less than a second predetermined value, which is smaller than the first predetermined value; and after the power consumption reducing function is activated, stopping the power consumption reducing function if it is determined that the measured discharge current value is less than the second predetermined value.

In the information processing apparatus, when the power consumption exceeds the first predetermined value, with the result that the power consumption reducing function is activated, even if the power consumption is reduced below the first predetermined value immediately thereafter, the operation is maintained until the power consumption is reduced under the second predetermined value which is set in consideration of the discharge current reduction due to the power consumption reducing function. The provision of the first and second predetermined values realizes a stable control of the power consumption reducing function without the problem of the conventional art that the activation and stoppage of the function is periodically repeated. Therefore, portable information equipment can be driven by a compact power source, even if the maximum power consumption thereof is large.

Additional objects and advantages of the invention will be set forth in the description which follows, and in part will be obvious from the description, or may be learned by practice of the invention. The objects and advantages of the invention may be realized and obtained by device of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 is an external view of an information processing apparatus according to an embodiment of the present invention;

FIG. 2 is a block diagram showing a system of the information processing apparatus according to the embodiment;

FIG. 3 is a diagram showing a state of a transition between the activation and the stoppage of a power consumption reducing function in the information processing apparatus of the embodiment;

FIG. 4 is a block diagram of an embedded controller of the information processing apparatus of the embodiment;

FIG. 5 is a graph showing a change of a battery pack discharge current below the rated discharge current in the information processing apparatus of the embodiment, in which the horizontal axis represents the time; and

FIG. 6A and FIG. 6B is a flowchart for explaining control procedures of the activation and stoppage of the power consumption reducing function executed by a power microcomputer of the information processing apparatus of the embodiment.

### DETAILED DESCRIPTION OF THE INVENTION

An embodiment of the present invention will be described with reference to the accompanying drawings. FIG. 1 is an external view of an information processing apparatus 100 according to an embodiment of the present invention. The information processing apparatus 100 is a portable apparatus, as for example, a PDA terminal, and it contains a battery pack 1 as a power source, as shown in FIG. 1. The information processing apparatus 100 performs a power consumption reducing function to temporarily reduce power consumption. The power consumption reducing function is used to prevent the discharge current of the battery pack 1, i.e., the power source of the information processing apparatus 100, from exceeding the rated value. At this time, in the embodiment of the present invention, the function is suitably controlled so as to solve the problem of the conventional art that the activation and stoppage of the function is repeated.

The rated value of the discharge current of the battery pack 1 is determined by protecting members incorporated in the battery pack 1. In general, the protecting members refer to elements operated in accordance with the relationship between a current and a temperature, such as a thermostat, a temperature fuse and a polyswitch. In other words, when the discharge current of the battery pack continuously exceeds a current determined by characteristics of the protecting member for a certain period of time, the temperature of the protecting members rise to turn off the switch. The rated value of the discharge current is determined on the basis of the protecting members in consideration of the acceptable temperature range of the discharge operation and safety performance.

The acceptable temperature range of the discharge operation is a specified range of temperatures, in which if the rated current is continuously discharged while the temperature remains in the specified range, the protecting members incorporated in the battery pack 1 are maintained in an ON state to ensure that the power supply line is not shut off. Generally, in addition to the discharge current that can be continuously discharged, a discharge current as a higher peak, which can be discharged in a limited period, can also be specified.

The safety performance ensures that the protecting members can be normally operated to maintain safe operation under abnormal conditions, such as a short cut, an over-voltage charge or an over-current charge of the battery pack 1.

The discharge current of the battery pack 1 can be specified in the two ways of “continuous discharge” and “limited-period discharge”. The present invention utilizes this characteristic. The discharge current from the battery pack 1 that supplies power to the information processing apparatus 100 is monitored. If the discharge current detection value in a “limited period” exceeds the discharge current specified as the “continuous discharge” (i.e., predetermined value 1 in FIG. 5), the power consumption reducing function is activated to control the discharge current within the specified range. To prevent the activation and stoppage of the power consumption reducing function from repeating periodically as in the conventional art, the current value to stop the power consumption reducing function is provided with hysteresis (delay width). As a result, the repetition of the activation and stoppage is prevented. The hysteresis current value, more particularly defined in formula (1) below, is the sum of the reduced discharge current of the battery pack 1 to activate the power consumption reducing function and a predetermined margin.

Control of activation of the power consumption reducing function and stoppage thereof, characteristic of the present invention, will now be described in detail.

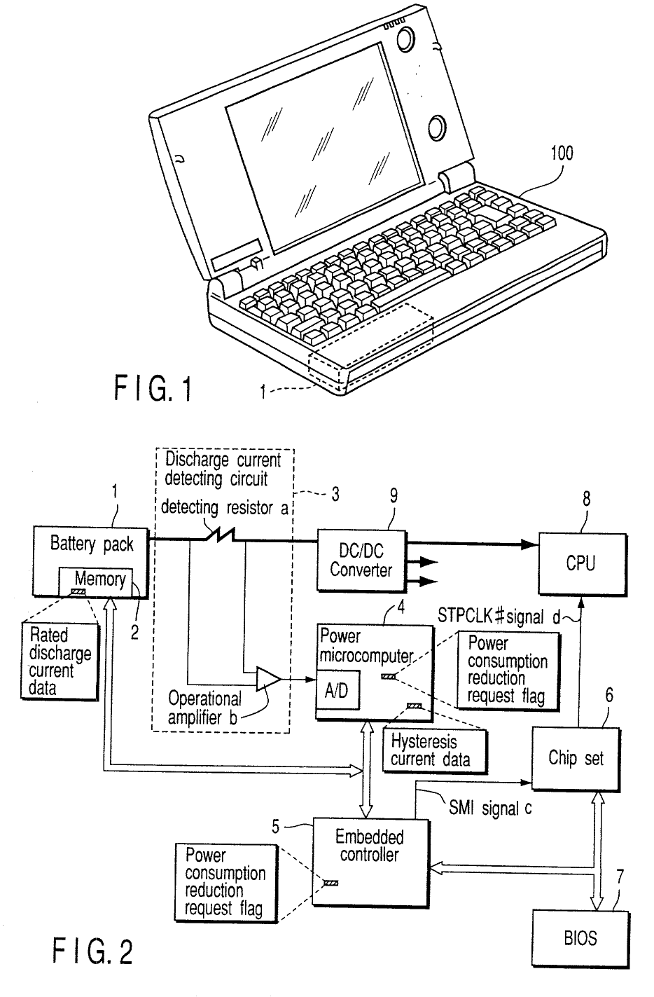

FIG. 2 is a block diagram showing a system of the information processing apparatus 100. In FIG. 2, an element 1 is a battery pack, which incorporates protecting members in a power source line to ensure safety. The battery pack 1 incorporates a memory 2, which stores a rated value of a discharge current (rated discharge current data).

In a circuit 3 for measuring a discharge current of the battery pack 1 (discharge current detecting circuit), a detecting resistor (a) is connected to a power supply line in series. Voltages at both ends of the detecting resistor (a) are input to an operational amplifier (b), so that the discharge current of the battery pack 1 is converted to a voltage value. As a result, the discharge current detecting circuit 3 outputs a signal of the voltage value converted from the detected discharge current.

A power microcomputer 4 executes connection status check of the battery pack 1, control of charge/discharge of the battery pack 1, calculation of the remaining capacity of the battery pack 1, etc.

The output signal of the discharge current detecting circuit 3 is guided to an A/D conversion input terminal of the power microcomputer 4. The power microcomputer 4 executes A/D conversion at a fixed cycle, and calculates the average value of the discharge current in a fixed period. The average value is utilized as discharge current measuring data of the battery pack 1.

The power microcomputer 4 can communicate with the memory 2 incorporated in the battery pack 1 through an I2C communication bus. It reads from the memory 2 the rated discharge current data specific to the battery pack 1, and stores it as a first predetermined value (a current value at which the power consumption reducing function is activated). It subtracts the hysteresis current from the first predetermined value, and stores the calculated value as a second predetermined value (a current value at which the power consumption reducing function is stopped). The first predetermined value (i.e., predetermined value 1 in FIG. 5) is the maximum value of the reduced discharge current of the battery pack 1 while the power consumption reducing function is active. For example, if it is assumed that the power consumption reducing function reduces the CPU speed by 50%, the hysteresis current is calculated by the following equation (1):

Hysteresis current={(Maximum value of the CPU power consumption×50%)}/(Battery discharge termination voltage)/(Power efficiency)+(Margin) (1)

The above formula may be used, for example, for calculating the decreasing amount of the discharge current of the battery pack corresponding to 50% reduction of the CPU load assuming a worst case condition wherein the CPU load is the maximum level and the battery voltage is the minimum level. The 50% reduction of the CPU load may be achieved by reducing the CPU duty cycle (or stopping ratio) to half level. As an example of the use of the above formula, assume initially that the power microcomputer 4 gets data from the memory 2 of the battery such as the “discharge current”, “maximum output voltage under a fully charged condition”, and the “minimum output voltage just before the discharge termination”. Assume initially that the maximum value of the CPU power consumption is 20W. When the circuit 3 detects that the current is over the predetermined first (upper) threshold value, the CPU duty cycle is reduced to a 50% level. Assume further that:

the battery discharge termination voltage is 9V;

the power efficiency of the circuit including the CPU is 80%; and

the margin is 10%.

If the CPU duty cycle is reduced by 50% while the maximum value of the CPU power consumption is 20W, then the decreased amount of CPU power consumption is 20W×50%=10W.

If the CPU power consumption is reduced to 10W, then the decreased amount of power consumption at an input portion of the circuit including the CPU (which is an output of the battery) is 10W/80%=12.5W.

The battery output voltage is gradually changed from the fully charged condition to the discharge termination condition, for example from 12.6V to 9.0V. As the smaller denominator makes the calculated amount bigger, 9.0V is utilized in this example in order to have a more conservative (larger) value of the hysteresis current. Under these assumptions, the decreased amount of the battery output voltage equals 12.5W/9.0V=1.39A.

If one considers that the detection circuit 3 has some error, one then adds a 10% margin so that the hysteresis current is 1.39A+0.139A=1.52A.

The hysteresis current (hysteresis current data) may be stored in the power microcomputer 4 as a fixed value. Alternatively, it may be stored as data in a BIOS 7 as a fixed value, and the data in the BIOS 7 may fed to the power microcomputer 4 through an embedded controller 5 during initialization of the system.

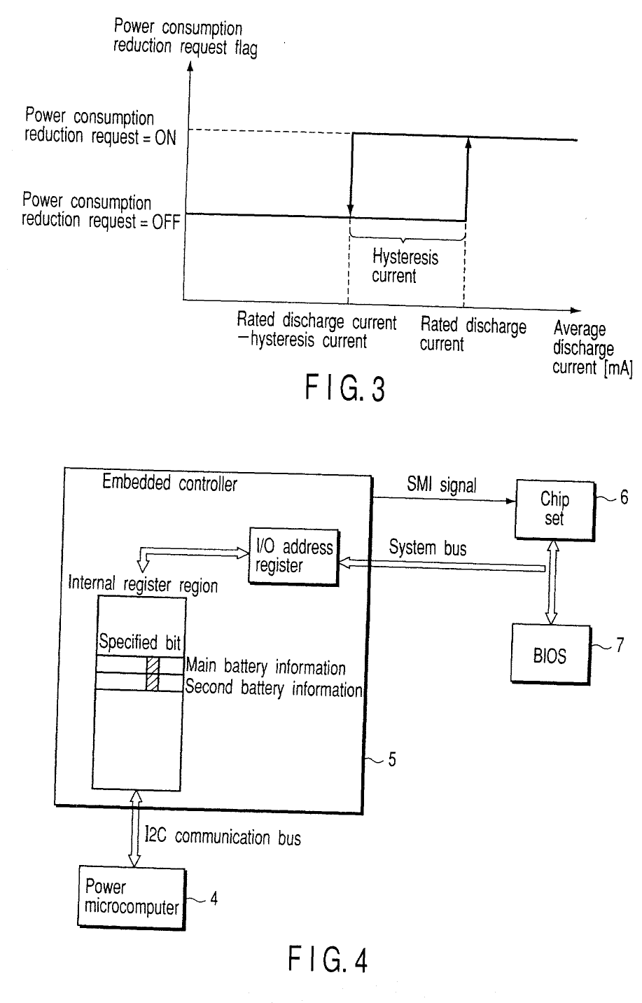

The power microcomputer 4 compares the discharge current measurement data obtained at the fixed cycle with the first and second predetermined values stored therein, so that the activation and stoppage (i.e., de-activation) of the power consumption reducing function of the BIOS 7 can be controlled suitably. Thus, the activation and stoppage of the power consumption reducing function is prevented from repeating periodically by the above-described hysteresis as shown in FIG. 3.

An embedded controller 5 defines a specified bit of the register of a specified address as a bit for requesting the activation or stoppage of the power consumption reducing function (power consumption reduction request flag). In this embodiment, the bit data=1 is determined as a request for the activation of the power consumption reducing function and the bit data=0 is determined as a request for the stoppage of the power consumption reducing function. The power microcomputer 4 writes the bit data through the I2C communication bus based on the result of the comparison between the discharge current measurement data and the first and second predetermined values. Thus, the power consumption reducing function is activated or stopped. When there is a change in the bit, the embedded controller 5 notifies the BIOS 7 of the occurrence of event.

The notification of the event, a so-called SMI (System Management Interrupt), is issued to a chip set 6 by means of an SMI signal (c). At the same time, the embedded controller 5 substitutes a code representing that the occurrence of the SMI is caused by the request for the activation or stoppage of the power consumption reducing function for a register assigned to the specified address of an I/O region read by the BIOS 7. In the meantime, the chip set 6 notifies the BIOS 7 that there is an SMI request from the embedded controller 5. The BIOS 7 reads the register of the embedded controller 5 assigned to the specified address of the I/O region. As described before, this register holds the code representing the factor of the occurrence of an event. If the code requests the activation or stoppage of the power consumption reducing function, the BIOS 7 further reads the specified bit of the register of the specified address of the embedded controller 5, and determines whether the request is the activation or stoppage of the power consumption reducing function. If it is determined that activation of the power consumption reducing function is requested, the BIOS 7 performs a register operation of the chip set 6, thereby activating a control signal (d) (STPCLK# signal) to stop the CPU operation at a certain duty cycle. By this operation, the predominantly large ratio of the power consumption of the CPU to that of the other devices in the information processing apparatus 100 is reduced by the amount corresponding to the reduced duty cycle. As a result, the power supplied from a DC/DC converter power circuit 9 to the CPU is reduced. It follows that the discharge current of the battery pack 1 in consideration of the power efficiency is reduced.

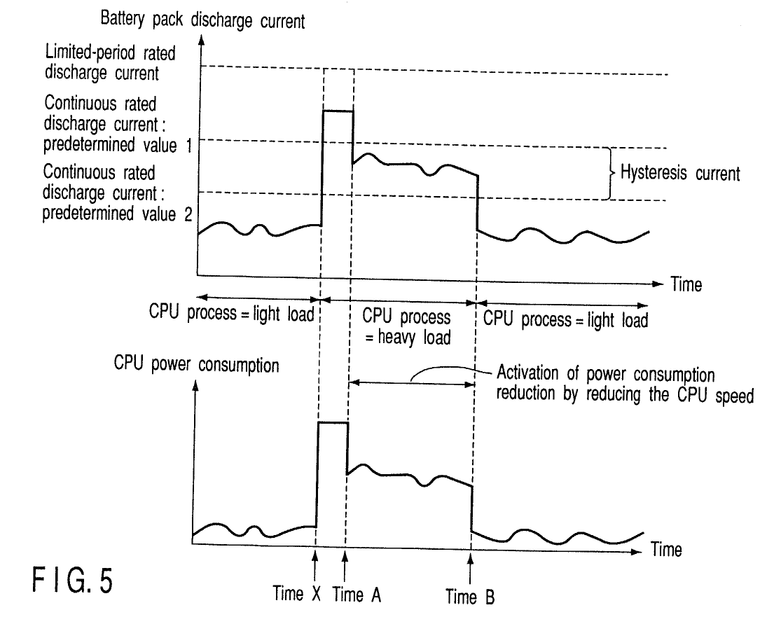

FIG. 4 is a block diagram of the embedded controller 5.

The power microcomputer 4 can directly access the register region inside the embedded controller 5 through the I2C communication bus. It writes the power consumption reduction request bit relating to the battery pack 1 defined in the register of the specified address. When there is a change in the bit data, the embedded controller 5 recognizes that an event occurs, writes a factor code in the register assigned to the specified address of the system I/O, and thereafter outputs an SMI request to the chip set 6. In this embodiment, the power consumption reduction request code is written as the factor code. The BIOS 7 is notified of the SMI request and starts an SMI routine. The BIOS 7 accesses the I/O register of the embedded controller 5 through the system bus and reads the factor data on the occurrence of the event. At this time, if it is determined that the register stores the power consumption reduction request code, the BIOS 7 further accesses the internal register within the embedded controller 5 via the I/O register to check the power consumption reduction request bit relating to the battery pack 1. Thus, the BIOS 7 can obtain information on the request for the activation or stoppage of the power consumption reducing function.

FIG. 5 is a graph showing a change of a battery pack discharge current reduced below the rated discharge current according to the reduction of the power consumption of the CPU by the operation of the BIOS 7 on a CPU speed reducing register incorporated in the chip set 6. In the graph, the horizontal axis represents the time. The first time period is defined from time zero to time X and corresponds to the condition when CPU processing is light. During this period, both the CPU power consumption and the battery pack discharge current are at a low level. In time period two, between time X and time A, the CPU load increases as does the CPU power consumption. As a result, the battery pack discharge current increases sharply, and this discharge current exceeds the predetermined value 1. During this second time period, the microcomputer 4 detects that the current is over the predetermined value 1 for a predetermined time period, and microcomputer 4 informs BIOS 7 of this condition by writing data=1 to a bit for requesting the activation of the power consumption deduction function in an internal register of EC5. Thereafter, EC 5 outputs the SMI signal to chip set 6. At time A, the BIOS 7 receives the request for activating the power consumption reducing function and reduces the CPU power, as for example, by reducing the duty cycle of the power to the CPU.

During a third time interval between time A and time B, both the CPU power consumption and the battery pack discharging current are decreased to a level between predetermined value 1 and value 2. The power consumption reducing function remains active.

In the fourth time period, after time B, the CPU load becomes light and the battery discharge current drops below predetermined level 2. The power microcomputer 4 detects this condition and request BIOS 7 via EC 5 to de-activate the power reducing function. At time B, the BIOS 7 receives the request for stopping the power consumption reducing function to cancel the reduction of the CPU speed.

As described above, the embodiment of the present invention uses the first predetermined value, at which the power consumption reducing function is activated, to temporarily reduce the power consumption. In addition, it uses the second predetermined value at which the power consumption reducing function is stopped, in consideration of the reduction of power (hysteresis current) in the power supply line due to the power consumption reducing function. The provision of the first and second predetermined values realizes a stable control of the power consumption reducing function without the problem of the conventional art that the activation and stoppage of the function is periodically repeated (i.e., without a time delay). Therefore, portable information equipment can be driven by a compact power source, even if the maximum power consumption thereof is large.

In this embodiment, a single battery pack 1 is used. However, if there are a plurality of battery packs 1, the same number of discharge current detecting circuits must be provided and the power microcomputer 4 must have the same number of A/D conversion input terminals. The power microcomputer 4 can be connected to the memories 2 incorporated in the battery packs 1 through the I2C communication bus. The power microcomputer 4 compares the discharge current data with the rated discharge current data of the battery packs 1. It writes the comparison result through the I2C communication bus in the specified bit of the register of the specified address defined for each battery pack 1 provided in the embedded controller 5. Thus, the discharge currents of the plurality of battery packs 1 can be controlled.

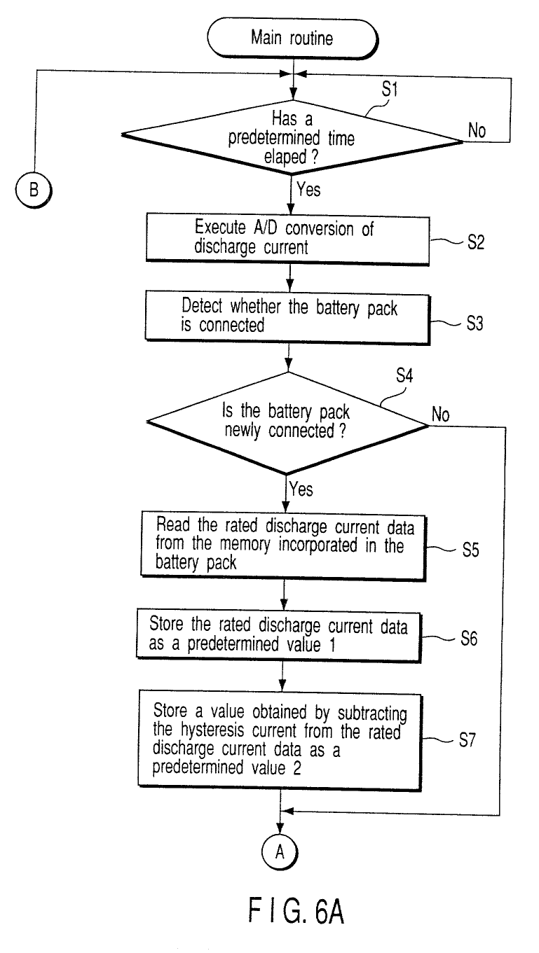

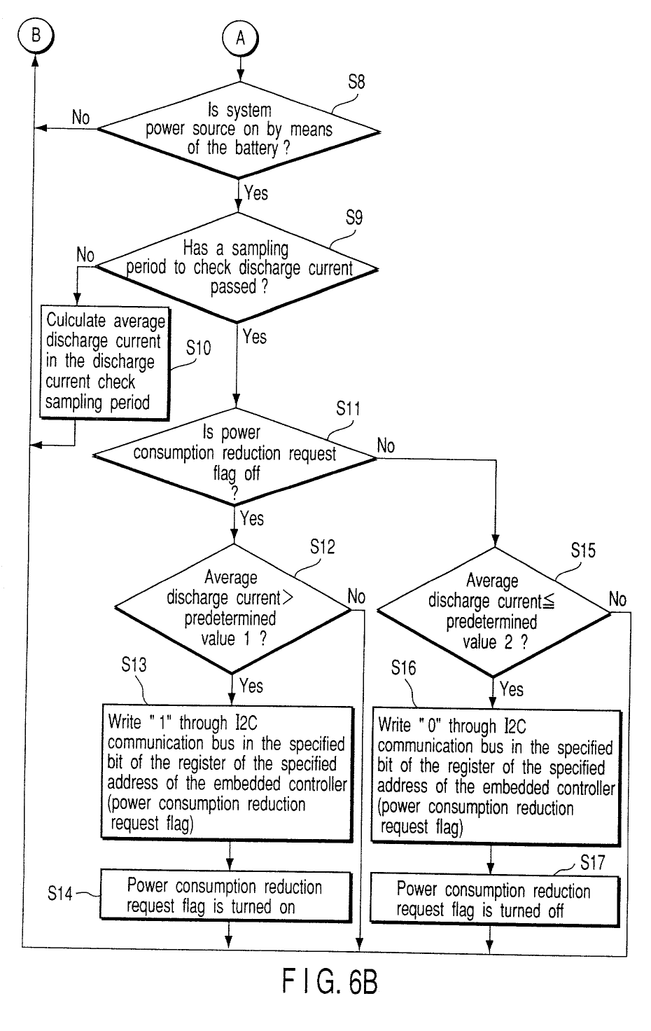

Control procedures of the activation and stoppage of the power consumption reducing function executed by the power microcomputer 4 will now be described with reference to FIG. 6A and FIG. 6B.

In order to execute the following process at a fixed cycle, every time a predetermined time has elapsed since the preceding execution of the process (YES in step S1), the power microcomputer 4 measures a discharge current of the battery pack 1 by A/D conversion (step S2). Then, the power microcomputer 4 checks the connection status of the battery pack 1 (step S3), and if the battery pack 1 is newly connected (YES in step S4), it reads the rated discharge current data from the memory 2 incorporated in the battery pack 1 (step S5). The power microcomputer 4 stores the read rated discharge current data as a predetermined value 1 (step S6), and stores a value obtained by subtracting the hysteresis current from the rated discharge current data as a predetermined value 2 (step S7).

The power microcomputer 4 has a fixed period timer for checking the discharge current, if the system power source is on by means of the battery (YES in step S8). With the timer, an average discharge current in a fixed period is calculated (NO in step S9, step S10). When the predetermined period has passed (YES in step 9), the calculated average discharge current is compared with the predetermined value 1 or the predetermined value 2. For this purpose, the power microcomputer 4 has a power consumption reduction request flag representing whether the power consumption reducing function is currently active or not. If the power consumption reduction request flag is off, i.e., if the power consumption reducing function is not active (YES in step S11), it is determined whether the average discharge current exceeds the predetermined value 1 (step S12). If the average discharge current exceeds the predetermined value 1 (YES in step S12), the power microcomputer 4 writes “1” through the I2C communication bus in the specified bit of the register defined as the specified address of the embedded controller 5 (step S13), thereby activating the power consumption reducing function. As a result, the power reduction consumption request flag is turned on (step S14).

On the other hand, if the power consumption reduction request flag is on, i.e., if the power consumption reducing function is active (NO in step S11), it is determined whether the average discharge current is equal to or less than the predetermined value 2 (step S15). If the average discharge current is equal to or less than the predetermined value 2 (YES in step S15), the power microcomputer 4 writes “0” through the I2C communication bus in the specified bit of the register defined as the specified address of the embedded controller 5 (step S16), thereby stopping the power consumption reducing function. As a result, the power reduction consumption request flag is turned off (step S17).

In the embodiment described above, the activation and stoppage of the power consumption reducing function in the case where the battery pack 1 is used as a power source is controlled. However, the present invention is not limited to the above embodiment. In the case where an AC adapter is used as a power source, the repetition of the activation and stoppage of the power consumption reducing function is also prevented in the same manner as in the above embodiment. In this case, the current and voltage values utilized to set the hysteresis current (and first and second predetermined values) are fixed in advance and are stored in the microcomputer 4. Alternatively, the BIOS can store such data and transfer same to the microcomputer 4.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus with a power consumption reducing function to temporarily reduce power consumption, the information processing apparatus being adapted to be driven by a battery and comprising:
measuring means for measuring a discharge current value of the battery;
first determining means for determining whether the discharge current value measured by the measuring means exceeds a first predetermined value;
second determining means for determining whether the discharge current value measured by the measuring means is less than a second predetermined value, which is smaller than the first predetermined value; and
control means for activating the power consumption reducing function if the first determining means determines that the discharge current measured by the measuring means exceeds the first predetermined value, and after the power consumption reducing function is activated, stopping the power consumption reducing function if the second determining means determines that the discharge current value measured by the measuring means is less than the second predetermined value.

2. An information processing apparatus according to claim 1, wherein the microprocessor retrieves battery data from the battery and calculates said first and second predetermined values based, at least in part, on said battery data, and wherein said information processing apparatus further comprises storing means for storing the first and second predetermined values.

3. An information processing apparatus according to claim 2, wherein the second predetermined value stored in the storing means is a value obtained by subtracting from a rated discharge current value of the battery a hysteresis current value equal to a maximum discharge current reduction value of the battery when the power consumption reducing function is activated.

4. An information processing apparatus according to claim 3, wherein the hysteresis current value is equal to {(a maximum value of a power consumption of a CPU mounted on the information processing apparatus)×(a reduction ratio of a CPU speed when the power consumption reducing function is active)}/(a battery discharge termination voltage)/(a power efficiency)+(a predetermined margin value).

5. An information processing apparatus with a power consumption reducing function to temporarily reduce power consumption, comprising:
measuring means for measuring a discharge current value of a power source which supplies power to operate the information processing apparatus;
first determining means for determining whether the discharge current value measured by the measuring means exceeds a first predetermined value;
second determining means for determining whether the discharge current value measured by the measuring means is less than a second predetermined value, which is smaller than the first predetermined value; and
control means for activating the power consumption reducing function if the first determining means determines that the discharge current measured by the measuring means exceeds the first predetermined value, and after the power consumption reducing function is activated, stopping the power consumption reducing function if the second determining means determines that the discharge current value measured by the measuring means is less than the second predetermined value.

6. A power consumption control method of an information processing apparatus with a power consumption reducing function to temporarily reduce power consumption, the information processing apparatus being capable of driven by a battery, said method comprising:
measuring a discharge current value of the battery;
determining whether the measured discharge current value exceeds a first predetermined value;
activating the power consumption reducing function if it is determined that the measured discharge current value exceeds the first predetermined value;
determining whether the measured discharge current value is less than a second predetermined value, which is smaller than the first predetermined value; and
after the power consumption reducing function is activated, stopping the power consumption reducing function if it is determined that the measured discharge current value is less than the second predetermined value.

7. A power consumption control method according to claim 6, wherein the second predetermined value is a value obtained by subtracting from a rated discharge current value of the battery a hysteresis current value equal to a maximum discharge current reduction value of the battery when the power consumption reducing function is activated.

8. A power consumption control method according to claim 7, wherein the hysteresis current value is equal to {(a maximum value of a power consumption of a CPU mounted on the information processing apparatus)×(a reduction ratio of a CPU speed when the power consumption reducing function is active)}/(a battery discharge termination voltage)/(a power efficiency)+(a predetermined margin value).

9. A power consumption control method of an information processing apparatus with a power consumption reducing function to temporarily reduce power consumption, said method comprising:
measuring a discharge current value of the battery;
determining whether the measured discharge current exceeds a first predetermined value;
activating the power consumption reducing function if it is determined that the measured discharge current value exceeds the first predetermined value;
determining whether the measured discharge current value is less than a second predetermined value, which is smaller than the first predetermined value; and
after the power consumption reducing function is activated, stopping the power consumption reducing function if it is determined that the measured discharge current value is less than the second predetermined value.

10. An information processing apparatus with a power consumption reducing function to temporarily reduce power consumption, the information processing apparatus adapted to be driven by a battery and comprising:
measuring means for measuring a discharge current value of the battery;
storing means for storing a plurality of predetermined values used to control activation and stoppage of the power consumption reducing function; and
control means for controlling the activation and stoppage of the power consumption reducing function based on the discharge current value measured by the measuring means and the plurality of predetermined values stored in the storing means.

11. An information processing apparatus with a power consumption reducing function to temporarily reduce power consumption, the information processing apparatus being adapted to be driven by a battery and comprising:
a measuring circuit for measuring a discharge current value of the battery;
said microprocessor operative for determining whether the discharge current value measured by the measuring circuit exceeds a first predetermined value;
said microprocessor operative for determining whether the discharge current value measured by the measuring means is less than a second predetermined value, which is smaller than the first predetermined value; and
a control device, including said microprocessor for activating the power consumption reducing function if the microcomputer determines that the discharge current measured by the measuring circuit exceeds the first predetermined value, and after the power consumption reducing function is activated, stopping the power consumption reducing function if the microcomputer determines that the discharge current value measured by the measuring device is less than the second predetermined value.

12. An information processing apparatus according to claim 11, further comprising a memory, accessible by said microcomputer, for storing the first and second predetermined values.

13. An information processing apparatus according to claim 12, wherein the second predetermined value stored in the memory is a value obtained by subtracting from a rated discharge current value of the battery a hysteresis current value equal to a maximum discharge current reduction value of the battery when the power consumption reducing function is activated.

14. An information processing apparatus according to claim 13, wherein the hysteresis current value is equal to {(a maximum value of a power consumption of a CPU mounted on the information processing apparatus)×(a reduction ratio of a CPU speed when the power consumption reducing function is active)}/(a battery discharge termination voltage)/(a power efficiency)+(a predetermined margin value).

15. An information processing apparatus with a power consumption reducing function to temporarily reduce power consumption, comprising:
a measuring circuit for measuring a discharge current value of a power source which supplies power to operate the information processing apparatus;
a first determining device for determining whether the discharge current value measured by the measuring circuit exceeds a first predetermined value;
a second determining device for determining whether the discharge current value measured by the measuring circuit is less than a second predetermined value, which is smaller than the first predetermined value; and
a control device for activating the power consumption reducing function if the first determining device determines that the discharge current measured by the measuring circuit exceeds the first predetermined value, and after the power consumption reducing function is activated, stopping the power consumption reducing function if the second determining device determines that the discharge current value measured by the measuring circuit is less than the second predetermined value.

16. An information processing apparatus with a power consumption reducing function to temporarily reduce power consumption, the information processing apparatus adapted to be driven by a battery and comprising:
a measuring device for measuring a discharge current value of the battery;
a storing device for storing a plurality of predetermined values used to control activation and stoppage of the power consumption reducing function; and
a control device for controlling the activation and stoppage of the power consumption reducing function based on the discharge current value measured by the measuring device and the plurality of predetermined values stored in the storing device.

17. An information processing apparatus as recited in claim 16, wherein said information processing apparatus retrieves battery data from said battery and calculates said plurality of predetermined values based, at least in part, on said retrieved battery data.
